(19) United States
(12) Patent Application Publication
(10) Pub. No.: US 2011/0096700 A1
(43) Pub. Date: Apr. 28, 2011

(54) Method For Duplexing a Clock Board

(76) Inventor: Eun Hae Bae, Seoul (KR)

(21) Appl. No.: 10/545,532

(22) PCT Filed: Mar. 24, 2004
(86) PCT No.: PCT/KR04/00656

§ 371 Date: May 30, 2006

(30) Foreign Application Priority Data
Mar. 25, 2003 (KR) 10-2003-0018555

(51) Int. Cl. H04L 5/14

(52) U.S. Cl. 370/276

(57) ABSTRACT

A method provides a technique to implement a circuit for duplexing a clock board that is applicable to all circuit elements within a base station which is synchronized by using a clock. More particularly, the method duplexes a clock board which is embodied to supply a stable clock in a CDMA (code division multiple access) System in such a manner that in case an active board is mounted/dismounted or its hardware is reset, a protection circuit logic is implemented for a board in standby mode (“a standby board”) to receive information of an Opponent board. This is so that a clock break during changing the board can be prevented by using the previously received information and the traditional complicated hardware circuits can be simplified by employing an EPLD (electrically programmable logic device).

### TECHNICAL FIELD

The present invention generally relates to a method for implementation of a circuit for duplexing a clock board that is applicable to all circuit elements within a base station which is synchronized by using a clock. More particularly, the present invention relates to a method for duplexing a clock board which is embodied to supply a stable clock in a CDMA (Code Division Multiple Access) system in such a manner that in case an active board is mounted/dismounted or its hardware is reset, a protection circuit logic is implemented for a board in standby mode (“a standby board”) to receive information of an opponent board. This is so that a clock break which may occur when changing the board can be prevented by using the received information and the hardware circuits can be simplified by employing only an EPLD (Electrically Programmable Logic Device).

### BACKGROUND ART

In general, boards in a digital mobile communication base station are synchronized by a CCDA (Clock Control Distribution Assembly) that receives a clock from a GPS (Global Positioning System) for distribution to the boards. The CCDA is duplexed during this time.

Here, the CCDA distributes the clock only when it is in an active mode while the opponent board is in the standby mode.

In case of mounting/dismounting an active board, a reset or a failure, a standby board, as shown in FIG. 1, receives a mounting/dismounting signal, a reset or error signal from an opponent board (e.g., the active board). It then enables a clock buffer immediately. The board in the active mode maintains its original mode for a time of 7 ns to 10 ns by a relay and then changes to the standby mode, wherein the standby board promptly changes to the active mode.

However, the prior art as explained above implements the duplexing process by using a hardware device such as a multiplexer (hereinafter, “MUX”) and the relay. This clearly degrades circuit stability and efficiency due to complexity of peripheral circuits.

### DISCLOSURE OF THE INVENTION

The object of the present invention is to provide a method for duplexing a clock board in order to supply a stable clock in a CDMA system. The present invention seeks to accomplish this objective in such a manner that in case an active board is mounted/dismounted or its hardware is reset, a protection circuit logic is implemented for a standby board to receive information related to an opponent board. Thus, clock disconnection which may occur while changing a board can be prevented by using the information and the hardware circuits and simplified by employing only an EPLD.

To accomplish the above-mentioned object, the method of duplexing a clock board according to the present invention comprises the steps of: checking whether current status of each board is normal when the power is turned on; checking whether a dismounting signal (sctl_rst signal) is normal when the board is in a normal state; continuing checking the status when the signal is abnormal, reading a slot ID of the signal and checking whether the value is 0 when the signal is normal; applying a delay of 10 ns when the value is not 0 and checking immediately whether an opponent board is in active or standby mode when the value is 0; and changing the opponent board's mode into active mode to output a clock when the opponent board is in the standby mode and shifting the opponent board's mode into the standby mode to disable the clock when the opponent board is in the active mode.

Further, to accomplish the objective of the present invention, the method of duplexing the clock board during dismounting an active board or a reset of a hardware comprises the steps of: determining whether an active board is dismounted or a hardware is reset; transmitting a dismounting signal (pwr_rst) to an opponent board when the active board is dismounted; maintaining a clock buffer enable signal for a preset time of 3 to 4 ns while transmitting the dismounting signal; enabling a clock buffer of the active board at the opponent board that receives the dismounting signal; and maintaining the delay such that a specific value is inputted to a selected register before the hardware is reset.

According to the present invention, if an active board is mounted/dismounted or its hardware is reset during duplexing a clock board to supply a stable clock in a CDMA system, then clock break which may occur during changing the board can be prevented by a protection circuit logic. The protection circuit logic enables a standby board to receive information related to an opponent board and uses the received information to protect from clock break during changing the board.

Further, the hardware circuit can be simplified by employing an EPLD logic. This significantly improves system stability and efficiency, in addition to saving manufacturing costs.

Additionally, the clock board as constituted above is applicable to every circuit elements in a base station which is adapted to synchronize through using a clock.

### BRIEF DESCRIPTION OF DRAWINGS

FIG. 1 shows a circuit configuration for duplexing a clock board according to a conventional apparatus;

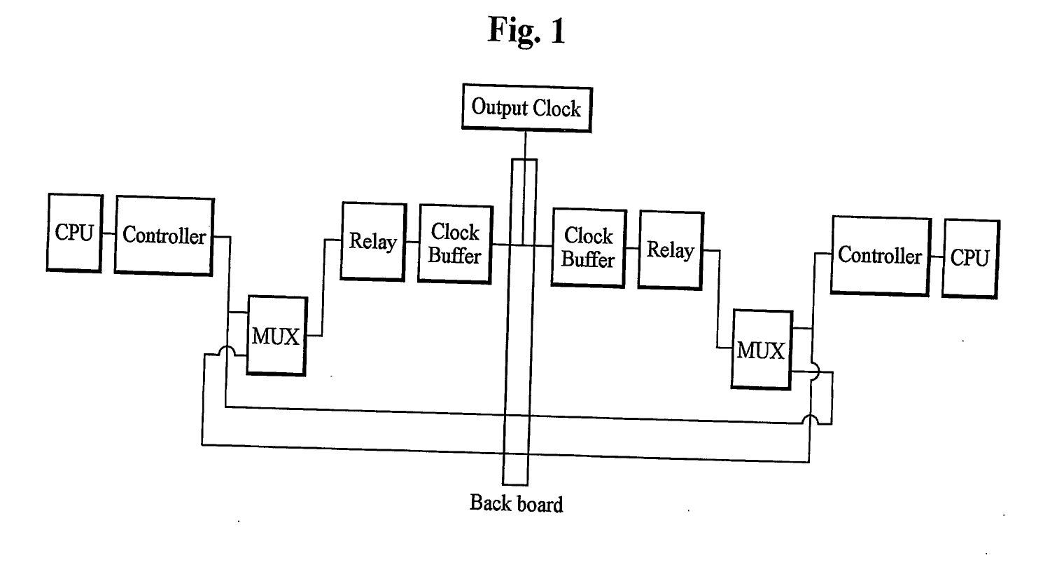

FIG. 2 shows a circuit configuration for duplexing a clock board according to the present invention;

FIG. 3 is a flow chart illustrating a method for duplexing a clock board according to the present invention; and

FIG. 4 is a flow chart illustrating a method for duplexing a clock board in case that an active board is dismounted or its hardware is reset.

### BEST MODE FOR CARRYING OUT THE INVENTION

Hereafter, the preferred embodiment of the present invention according to the above-mentioned technical features of the present invention will be described the accompanying drawing below.

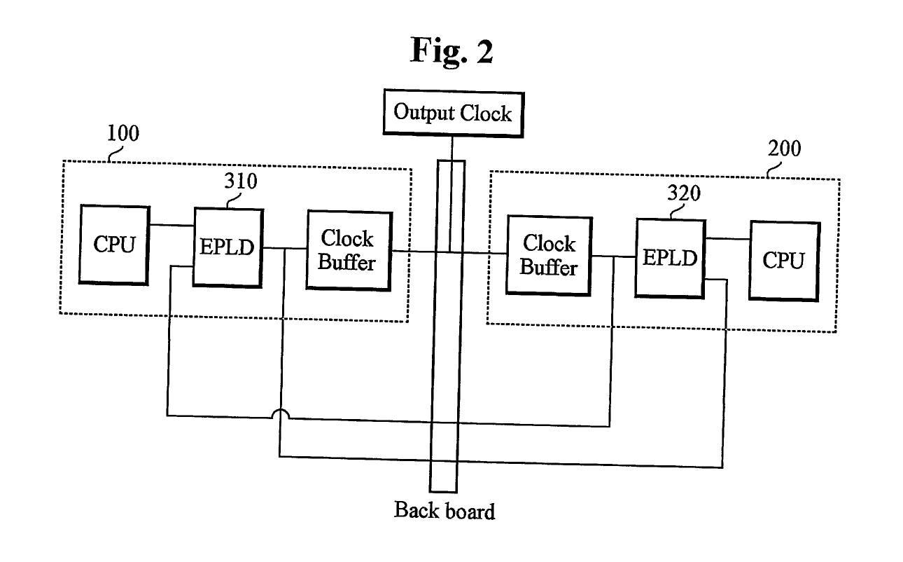

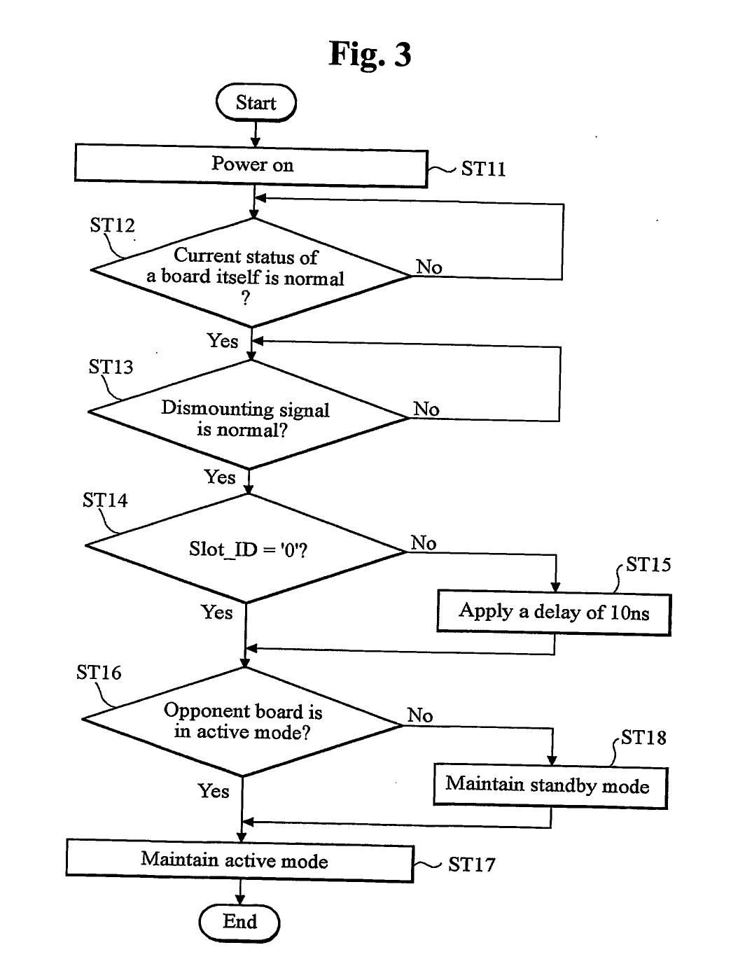

FIG. 2 is a circuit configuration for duplexing a clock board according to the present invention. FIG. 3 is a flow chart for illustrating a method for duplexing a clock board according to the present invention.

As shown, the circuit board for duplexing according to the present invention is implemented such that in case an active board 100 is mounted/dismounted or its hardware resets (especially during duplexing) a clock board in order to supply a stable clock in a CDMA (code division multiple access) system, a standby board 200 receives information related to an opponent board (i.e., the active board) and is simply implemented by using only EPLD 310, 320.

The present invention comprises the steps of: when a power is turned on (ST11), checking whether current status of each board is normal (ST12); checking whether a dismounting signal (sctl_rst signal) is normal when the board is in normal state (ST13); continuing checking the status when the signal is abnormal, reading a slot ID of the signal and checking whether the value is 0 when the signal is normal (ST14); applying a delay of 10 ns when the value is not 0 (ST15) and checking immediately whether an opponent board is in active or standby mode when the value is 0 (ST16); and changing the opponent board's mode into active mode to output a clock when the opponent board is in the standby mode (ST17) and shifting the opponent board's mode into then standby mode to disable the clock when the opponent board is in the active mode (ST18).

In other words, a method for duplexing a clock board according to the present invention is simply implemented by employing only an EPLD. Each board checks whether it is in a normal state when the power is turned on.

When the board is not in the normal state, it continues to check its status. When the board is in the normal state, it checks whether the sctl_rst signal (i.e., its dismounting signal) is normal.

When the dismounting signal is normal, the board reads out its own slot ID. When a value of the slot ID is 0 (zero), the board promptly checks whether an opponent board is in active mode or in standby mode. When the opponent board is in the standby mode, the board changes into the active mode (e.g., it outputs a clock). When the opponent board is in the active mode, it maintains the standby mode (e.g., it disables a clock).

Meanwhile, when the board reads out its own slot ID and the value of the slot ID is 1, it applies a delay of 10 ns. It then checks whether the opponent board is in the active mode or the standby mode. When the opponent board is in the standby mode, it changes into the active mode. When the opponent board is in the active mode, it maintains the standby mode.

The current configuration of the clock board aims to prevent the two boards from being changed to active mode simultaneously when the power is turned on.

Further, a solution for a stable clock output to the opponent board during dismounting a board or a reset of hardware will follow hereinafter.

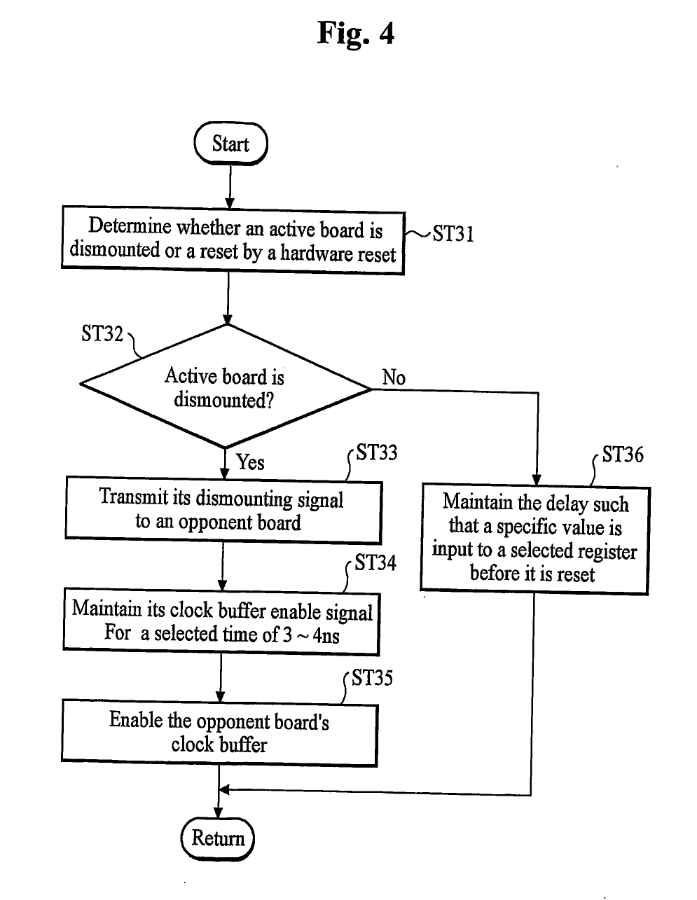

FIG. 4 is a flow chart illustrating the method for duplexing a clock board in case of dismounting an active board or a reset of hardware.

As illustrated, the present invention includes the steps of: determining whether an active board is dismounted or a hardware is reset (ST31)(ST32); transmitting a dismounting signal (pwr_rst) to an opponent board when the active board is dismounted (ST33); maintaining a clock buffer enable signal for a preset time of 3 to 4 ns while transmitting the dismounting signal (ST34); enabling a clock buffer of the active board at the opponent board that receives the dismounting signal (ST35); and maintaining the delay such that a specific value is inputted to a selected register before the hardware is reset when the hardware is reset (ST36).

In other words, in order to stably provide a clock by an opponent board during dismounting of an active board (that currently generates a clock), the active board transmits a dismounting signal (pwr_rst) to the opponent board before it is dismounted. The opponent board receiving the dismounting signal enables its clock buffer that has been disabled.

Here, the active board is designed to maintain the clock buffer enable signal for a time of approximately 3 ns to 4 ns at the time of its dismounting. This allows its own clock buffer enable signals to overlap with those of the opponent board (standby board), thereby making a stable clock output by the opponent board.

Further, in case of a hardware reset of the active board, it is also implemented in the same routine as in the case of dismounting. In case of software reset at the active board, a specific register is written with any value to maintain a delay before it is reset. The opponent board receives the signal to enable its own clock buffer.

While the present invention has been shown and described with respect to a particular method for duplexing a clock board, it will be apparent to those skilled in the art that many changes and modifications may be made without departing from the scope of the invention as defined in the appended claims and those equivalent thereto.

1. A method of duplexing a clock board in a CDMA system, comprising the steps of:
checking whether current status of each board itself is normal when a power is turned on;
checking whether a dismounting signal (sctl_rst signal) is normal when the board is in normal state;
continuing checking the status when the signal is abnormal, reading a slot ID of the signal and checking whether the value is 0 when the signal is normal;
applying a delay of 10 ns when the value is not 0 and checking immediately whether an opponent board is in active or standby mode when the value is 0; and
changing the opponent board's mode into active mode to output a clock when the opponent board is in the standby mode and shifting the opponent board's mode into the standby mode to disable the clock when the opponent board is in active mode.

2. The method of claim 1 wherein the method of duplexing of the clock board during dismounting an active board or a hardware reset, comprises the steps of:
determining whether the active board is dismounted or the hardware is reset;
transmitting a dismounting signal (pwr_rst) to the opponent board when the active board is dismounted;
maintaining a clock buffer enable signal for a preset time of 3 to 4 ns while transmitting the dismounting signal;
enabling a clock buffer of the active board at the opponent board that receives the dismounting signal; and,
maintaining the delay such that a specific value is inputted to a selected register before the hardware is reset when the hardware is reset.
